(19) United States
(12) Patent Application Publication
(10) Pub. No.: US 2009/0044640 A1
(43) Pub. Date: Feb. 19, 2009

(54) Electronic Pen With a Three-Dimensional Force Sensor

(75) Inventors: Andrea Vassilev, Grenoble (FR); Jean-Michel Ittel, Les Adrets (FR)

Correspondence Address: OLIFF & BERRIDGE, PLC, P.O. BOX 320850, ALEXANDRIA, VA, 22320-4850, US

(73) Assignee: Commissariat A L'Energie Atomique, Paris (FR)

(21) Appl. No.: 11/922,485

(22) PCT Filed: Jul. 6, 2006
(86) PCT No.: PCT/FR2006/001624

§ 371 Date: Dec. 19, 2007

(30) Foreign Application Priority Data
Jul. 12, 2005 (FR) 05 07467

(51) Int. Cl. G01L 1/00; B43K 8/00

(52) U.S. Cl. 73/862.541; 401/194

(57) ABSTRACT

The electronic pen comprises a lead equipped with a tip, an ink container and a three-dimensional force sensor for measuring the forces applied on the lead by a user. The three-dimensional force sensor, placed for example at a distance of less than 15 mm from the tip of the lead, comprises a sensitive detection element placed in the axis of the tip of the lead The pen comprises a first element made of flexible material arranged between the ink container and the three-dimensional force sensor to transmit the forces applied on the lead to the three-dimensional force sensor. The pen can comprise a second element made of flexible material for securing the ink container inside the lead.

### BACKGROUND OF THE INVENTION

The invention relates to an electronic pen comprising a lead equipped with a tip and an ink container, and detection means associated with the lead comprising a force sensor designed to measure the forces applied on the lead by the user.

### STATE OF THE ART

Electronic stylus pens are conventionally designed to digitize writing and to capture graphic gestures. To achieve this objective, current electronic pens, in particular the electronic pen described in U.S. Pat. No. 4,751,741, use measurement of the forces applied on the lead by the user. In addition, they are generally equipped with a standard cylindrical-shaped ink cartridge with a length of about 50 mm to 100 mm. The ink cartridge is equipped with several force sensors placed on the body thereof in three orthogonal directions of a reference frame.

Electronic pens of this kind present several shortcomings. The cartridge is relatively long and the force sensors are placed far from the tip of the lead, which can lead to measurements that are not representative of the force applied on the lead. The force sensors are numerous, which can give rise to problems of space occupation inside the pen. The sensors are placed on the body of the cartridge, which can result in handling problems and damage when changing the cartridge.

### OBJECT OF THE INVENTION

The object of the invention is to remedy the above-mentioned shortcomings and has the object of providing a high-performance electronic pen enabling writing to be performed using precise and reliable measurements of the forces applied on its lead.

The object of the invention is characterized in that the force sensor is a three-dimensional force sensor comprising a sensitive detection element placed in the axis of the tip of the lead, and that the pen comprises at least a first element made of flexible material arranged between the ink container and the three-dimensional force sensor.

### BRIEF DESCRIPTION OF THE DRAWINGS

Other advantages and features will become more clearly apparent from the following description of particular embodiments of the invention given as non-restrictive examples only and represented in the accompanying drawings, in which:

FIG. 1 is a partial cross-sectional view of a particular embodiment of an electronic pen according to the invention.

FIG. 2 is a partial cross-sectional view of an alternative embodiment of an electronic pen according to the invention.

### DESCRIPTION OF PARTICULAR EMBODIMENTS

In the figures, an electronic pen 1 is particularly designed for writing and for measuring the forces applied on its lead. Electronic pen 1 comprises a lead 2 equipped with a tip 3, securedly fixed to an ink container 4 partially housed inside a lead body 5, which is for example substantially tubular-shaped. Ink container 4 comprises a preferably substantially conical-shaped upper part 4a equipped at its end with tip 3 and salient from lead body 5 to form the free end of electronic pen 1. Ink container 4 delineates a cavity wherein the ink is stored, tip 3 passing through substantially conical-shaped upper part 4a to be in contact with the ink contained in ink container 4.

Pen 1 comprises a three-dimensional force sensor 6 designed to detect all the forces applied by the user on lead 2. Force sensor 6 in particular comprises a sensitive detection element 7, that is for example substantially cylindrical-shaped, placed at the level of an axis of symmetry 8 of electronic pen 1. Sensitive element 7 is designed to detect all the forces exerted on lead 2 of the pen in the three orthogonal directions of the reference system relative to electronic pen 1.

Moreover, three-dimensional force sensor 6 is supported by a support 9 arranged perpendicularly to axis of symmetry 8 of pen 1, inside lead body 5.

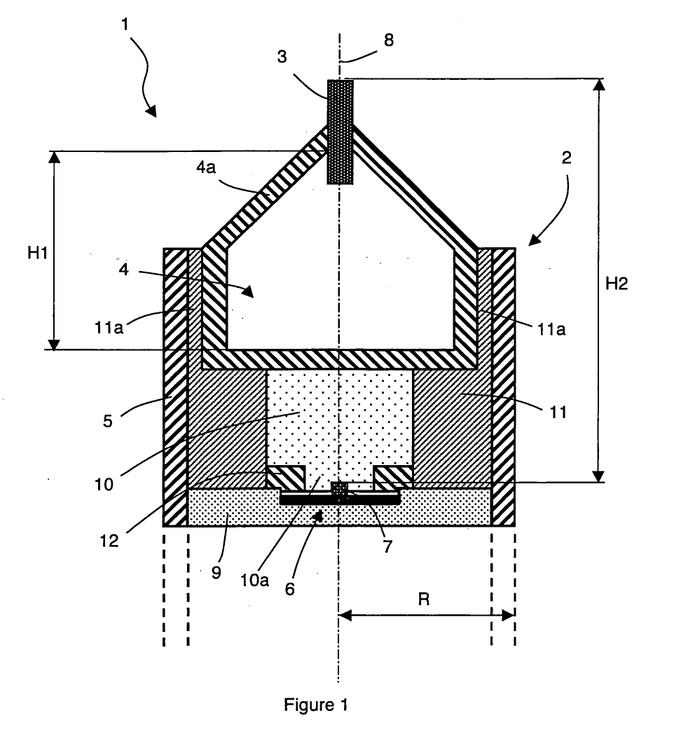

In the particular embodiment of FIG. 1, pen 1 comprises a first element 10 made of flexible material arranged between ink container 4 and three-dimensional force sensor 6. First flexible material element 10 acts as means for transmitting forces between tip 3, securedly fixed to ink container 4, and three-dimensional force sensor 6.

For example, first flexible material element 10 is made of polyurethane with a stiffness of less than 10 MPa. First element 10 can preferably be produced by machining a block of polyurethane or by molding. The stiffness of first flexible material element 10 is chosen such that first flexible material element 10 protects three-dimensional force sensor 6, while transmitting the forces correctly.

In FIG. 1, ink container 4 is wider than first element 10 made of flexible material. Electronic pen 1 advantageously comprises a second element 11 made of flexible material, surrounding first flexible material element 10 and acting as support for ink container 4. Second flexible material element 11 rests on support 9 of three-dimensional sensor 6.

Moreover, ink container 4 does not completely fill the inside of lead body 5. Second flexible material element 11 comprises a salient part 11a, shaped as an annular crown of small thickness, surrounding ink container 4 inside lead body 5. Second flexible material element 11 therefore acts mainly as support element for ink container 4 inside lead body 5.

For example, second flexible material element 11 is made of foam with a stiffness of about 0.1 MPa. The stiffness of second element 11 is particularly chosen such that ink container 4 equipped with tip 3 is held without clearance inside lead body 5.

In the particular embodiment represented in FIG. 1, first flexible material element 10 comprises a narrower part 10a directly in contact with sensitive detection element 7 of three-dimensional force sensor 6. Narrower part 10a is preferably surrounded by a third element 12 made of flexible material, adjacent to second flexible material element 11 and partially in contact with three-dimensional force sensor 6.

Third flexible material element 12 is therefore adjacent both to first flexible material element 10, to second flexible material element 11, to the edges of three-dimensional force sensor 6 and to support 9 of three-dimensional force sensor 6. Third flexible material element 12 is particularly designed to reduce the overall stiffness of electronic pen 1. For example, third flexible material element 12 is made of silicone glue with a stiffness of about 1 MPa.

In FIG. 1, flexible material elements 10, 11, 12 serve the purpose of securing the elements inside lead body 5, i.e. ink container 4 and three-dimensional force sensor 6, and act as transmission means of the forces between tip 3 of lead 2 and three-dimensional force sensor 6. First flexible material element 10 is designed to transmit the forces to three-dimensional force sensor 6, whereas second flexible material element 11 is designed to secure and act as support for ink container 4 inside lead body 5, and third flexible material element 12 serves the purpose of making electronic pen 1 more flexible.

For example, for a radius R of lead body 5 of about 7 mm, the height H1 of ink container 4 is about 5 mm, with a volume of more than 500 mm³, and three-dimensional force sensor 6 is situated at a distance H2 of less than 15 mm is with respect to the end of tip 3 of lead 2. Three-dimensional force sensor 6 is preferably achieved by means of microtechnology techniques.

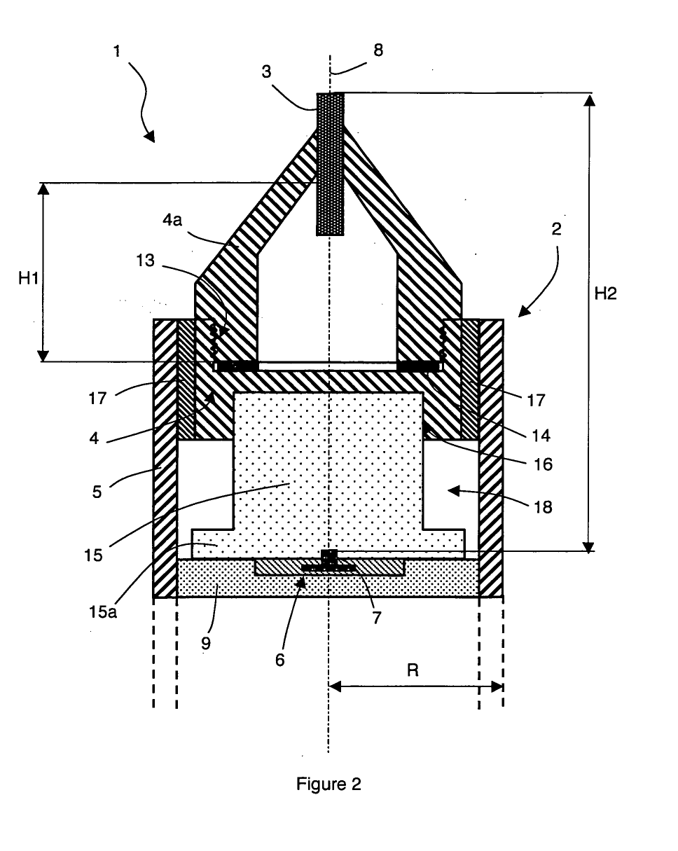

In the alternative embodiment represented in FIG. 2, electronic pen 1 differs from the previous embodiment in particular by the shape of ink container 4. Upper part 4a of ink container 4 is removable with respect to the fixed part of container 4 housed in lead body 5. For example, upper part 4a is fitted rotating on the fixed part of container 4 by means of a thread 13, thus enabling tip 3 of pen 1 to be disassembled simply and quickly. In this case, ink container 4 comprises a seal 14 fitted between the fixed part and the removable part of ink container 4 to give pen 1a good tightness.

Electronic pen 1 always comprises three-dimensional force sensor 6 positioned along the axis 8 of pen 1 and a first element 15 made of flexible material arranged between ink container 4 and three-dimensional force sensor 6. In the particular embodiment of FIG. 2, first flexible material element 15 comprises a widened base 15a, directly in contact with sensitive detection element 7 and designed to increase the contact surface between support 9 and first flexible material element 15. Moreover, ink container 4 preferably comprises a recess 16, formed at the base of its fixed part, inside which first flexible material element 15 is housed (FIG. 2).

As before, first flexible material element 15 is designed to transmit the forces applied on lead 2 to three-dimensional force sensor 6. For example, first flexible material element 15 is made of polyurethane with a stiffness of less than 10 MPa and can be produced by machining a block of polyurethane or by molding. The stiffness of first flexible material element 15 is chosen such that first flexible material element 15 protects three-dimensional force sensor 6, while transmitting the forces correctly.

Electronic pen 1 also comprises a second element 17 made of flexible material surrounding ink container 4 inside lead body 5. Second flexible material element 17, shaped as an annular crown of small thickness, is designed to secure the fixed part of ink container 4 inside lead body 5.

As before, second flexible material element 17 is for example made of foam with a stiffness of about 0.1 MPa. The stiffness of second element 17 is particularly chosen in such a way that ink container 4 is held without any clearance inside lead body 5.

Moreover, first flexible material element 15 and second flexible material element 17 delineate a cavity 18 inside lead body 5 in particular enabling first flexible material element 15 to deform freely when pen 1 is used. This results in optimal transmission of the forces to three-dimensional force sensor 6.

As before, for a radius R of lead body 5 of about 7 mm, the height H1 of ink container 4 is about 5 mm, with a volume of more than 500 mm³, and three-dimensional force sensor 6 is situated at a distance H2 of less than 15 mm from the end of tip 3 of lead 2.

Whatever the embodiment of electronic pen 1, the latter enables very reliable and very precise measurements to be made, in particular on account of the positioning of three-dimensional force sensor 6 very close to tip 3 of lead 2 and exactly in the axis 8 of the latter. Furthermore, the space occupied inside pen 1 is minimal due to the use of a single three-dimensional force sensor 6, preferably achieved by means of microtechnology techniques.

Furthermore, as three-dimensional force sensor 6 is independent from ink container 4 of pen 1, ink container 4 can be changed and refilled without touching three-dimensional force sensor 6. Refilling of ink container 4 is therefore simplified and handling of electronic pen 1 is made easier, in particular due to removable top part 4a of ink container 4 (FIG. 2).

The invention is not limited to the different embodiments described above. It is possible to use any type of three-dimensional force sensor 6. Flexible material elements 10, 11, 12, 15, 17 can be formed by any other flexible material and can have a quite different shape provided that they enable three-dimensional force sensor 6 and ink container 4 to be secured inside lead body 5 and the forces to be transmitted between tip 3 of lead 2 and three-dimensional force sensor 6.

Furthermore, the height H1 of ink container 4, the height H2 between three-dimensional force sensor 6 and the end of tip 3 and the radius R of lead body 5 are non-restrictive dimensions and depend in practice on the general size of the electronic pen 1 involved.

Such an electronic pen 1 is used particularly to determine the trajectory of lead 2 of pen 1 in the plane of a sheet, by means of electronic retranscription functions, and to characterize, authenticate and/or recognize a signature.

1. An electronic pen comprising a lead equipped with a tip and an ink container, and detection means associated with the lead, comprising a force sensor designed to measure the forces applied on the lead by a user, wherein the force sensor is a three-dimensional force sensor comprising a sensitive detection element placed in the axis of the tip of the lead, and the pen comprises at least a first element, made of flexible material, arranged between the ink container and the three-dimensional force sensor.

2. The pen according to claim 1, wherein the first flexible material element is made of polyurethane with a stiffness of less than 10 MPa.

3. The pen according to claim 1, wherein the three-dimensional force sensor is placed at a distance of less than 15 mm from the tip of the lead.

4. The pen according to claim 1, wherein the ink container has a volume larger than 500 mm³.

5. The pen according to claim 1, wherein the ink container and the first flexible material element are surrounded by a second element made of flexible material.

6. The pen according to claim 5, wherein the ink container is wider than the first flexible material element and the second flexible material element comprises a salient part surrounding the ink containers.

7. The pen according to claim 1, wherein the ink container is surrounded by a second element made of flexible material.

8. The pen according to claim 7, wherein the ink container comprises at its base a recess housing the first flexible material element.

9. The pen according to claim 7, wherein the first flexible material element comprises a widened base in contact with the sensitive detection element.

10. The pen according to claim 5, wherein the second flexible material element is made of foam with a stiffness of about 0.1 MPa.

11. The pen according to claim 1, wherein the first flexible material element is directly in contact with the sensitive detection element by means of a narrower part of said first element surrounded by a third flexible material element at least partially in contact with the three-dimensional force sensor.

12. The pen according to claim 11, wherein the third flexible material element is made of silicone glue with a stiffness of about 1 MPa.

13. The pen according to claim 1, wherein the ink container comprises a removable upper part.
